(19) United States
(12) Patent Application Publication
(10) Pub. No.: US 2025/0247272 A1
(43) Pub. Date: Jul. 31, 2025

(54) DECISION FEEDBACK EQUALIZER

(71) Applicant: TEXAS INSTRUMENTS INCORPORATED, Dallas, TX (US)

(72) Inventors: Raghu GANESAN, Bangalore (IN); Kalpesh Laxmanbhai RAJAI, Bangalore (IN); Saravanakkumar RADHAKRISHNAN, Aruppukottai (IN)

(21) Appl. No.: 18/428,268

(22) Filed: Jan. 31, 2024

(51) Int. Cl. H04L 25/03

(52) U.S. Cl. CPC H04L 25/03057

(57) ABSTRACT

A circuit includes a partial sum circuit and a first decision feedback equalizer (DFE) path. The partial sum circuit generates partial sum values by summing DFE outputs. The first DFE path is coupled to the partial sum circuit, and includes a first adder circuit, first and second multiplexers, a two's complement circuit, and a first slicer. The first adder circuit generates a sum of a first subset of the partial sum values. The first multiplexer has a first input coupled to an output of the first adder circuit. The two's complement circuit has an input coupled to an output of the first multiplexer. The second multiplexer has an input coupled to the output of the first multiplexer, and a second input coupled to an output of the two's complement circuit. The first slicer has an input coupled to the output of the second multiplexer.

### BACKGROUND

Serial communication links experience high frequency distortion (phase and amplitude) between the transmitter and receiver over a lossy channel. This distortion is manifested at the receiver as inter-symbol interference, i.e., a smearing of the transmitted data bits/symbols. Channel equalization is used to counteract inter-symbol interference and other channel induced distortion. Channel equalization may be applied using transmission pre-emphasis that pre-distorts a transmit signal and/or as receiver equalization that applies post-compensation for the undesirable frequency effects of the channel.

### SUMMARY

In one example, a circuit includes a partial sum circuit and a first decision feedback equalizer path. The partial sum circuit is configured to generate partial sum values by summing decision feedback equalizer outputs. The first decision feedback equalizer path is coupled to the partial sum circuit. The first decision feedback equalizer path includes a first adder circuit, first and second multiplexers, a first two's complement circuit, and a first slicer. The first adder circuit is configured to generate a sum of a first subset of the partial sum values. The first multiplexer has a first input coupled to an output of the first adder circuit, and an output. The first two's complement circuit has an input coupled to the output of the first multiplexer and an output. The second multiplexer has a first input coupled to the output of the first multiplexer, and a second input coupled to the output of the first two's complement circuit. The first slicer has an input coupled to the output of the second multiplexer.

In another example, a circuit includes a partial sum circuit, and first and second decision equalizer paths. The partial sum circuit is configured to generate partial sum values by summing decision feedback equalizer outputs. The first decision feedback equalizer path includes a first adder circuit, a first multiplexer, and a first slicer. The first adder circuit has a first output and a second output. The first adder circuit is configured to generate a sum of a first subset of the partial sum values. The first multiplexer has a first input coupled to the first output of the first adder circuit, and an output. The first slicer is coupled to the output of the first multiplexer. The second decision feedback equalizer path includes a second adder circuit, a second multiplexer, and a second slicer. The second adder circuit has an output. The second adder circuit is configured to generate a sum of a second subset of the partial sum values. The second multiplexer has a first input coupled to the second output of the first adder circuit, a second input coupled to the output of the second adder circuit, and an output. The second slicer has an input coupled to the output of the second multiplexer.

In a further example, a circuit includes a partial sum circuit and a first decision feedback equalizer path. The partial sum circuit is configured to generate partial sum values by summing decision feedback equalizer outputs. The first decision feedback equalizer path includes a first adder circuit. The first adder circuit is configured to generate a sum of a first subset of the partial sum values. The first adder circuit includes a first multiplexer and a first adder. The first multiplexer has an input coupled to the partial sum circuit, and an output. The first adder has a first input coupled to the output of the first multiplexer, a second input coupled to the partial sum circuit, and an output. The first decision feedback equalizer path also includes a second multiplexer and a first slicer. The second multiplexer has a first input coupled to the output of the first adder, and an output. The first slicer has an input coupled to the output of the second multiplexer.

### BRIEF DESCRIPTION OF THE DRAWINGS

FIGS. 1A and 1B are a block diagram of an example receiver circuit that includes a decision feedback equalizer.

FIG. 2 is a block diagram of an example parallel decision feedback equalizer circuit suitable for use as the decision feedback equalizer of FIG. 1.

FIGS. 3 and 4 are block diagrams of example decision feedback equalizer paths that take advantage of symmetry of path output values to reduce path circuitry.

FIG. 5 is a block diagram of two example decision feedback equalizer paths in which partials sum determined in a first path are used in both the first and second paths.

FIGS. 6 and 7 are block diagrams of example decision feedback equalizer paths that include multiplexers that take advantage of sequential computation of decisions in previous decision feedback equalizer paths.

FIG. 8 is a block diagram of an example decision feedback equalizer path that includes the multiplexing of FIG. 6 and the symmetry exploitation of FIG. 3.

FIG. 9 is a block diagram of an example multiplexer suitable for use in the decision feedback paths of the decision feedback equalizer of FIG. 1.

### DETAILED DESCRIPTION

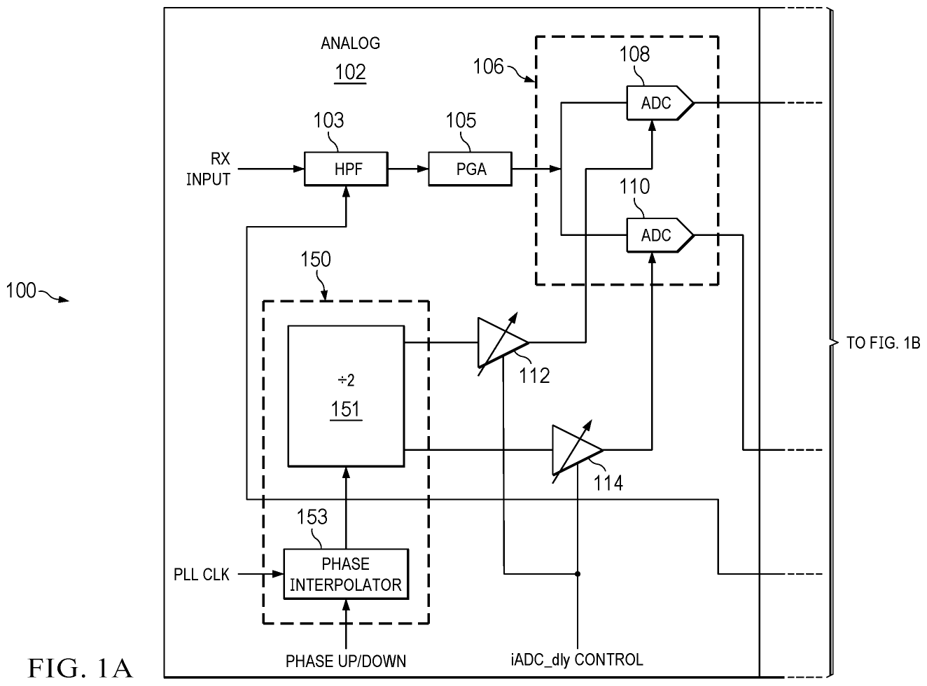

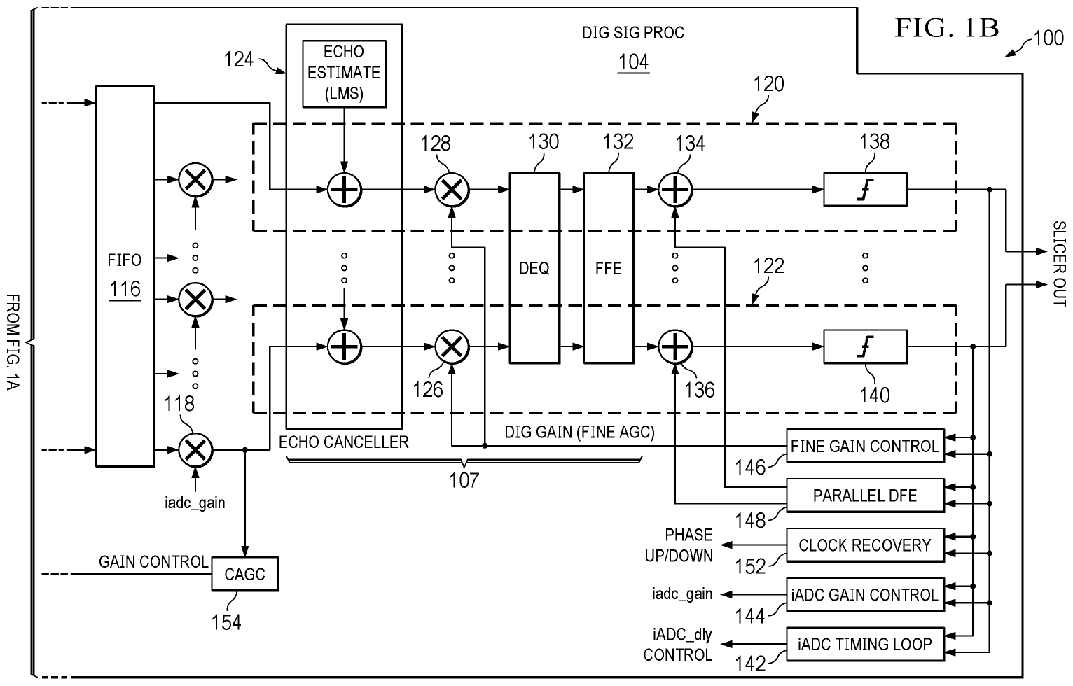

FIGS. 1A and 1B show a block diagram for example receiver physical layer (PHY) circuitry 100 that includes a decision feedback equalizer. Examples of the receiver physical layer circuitry may be applied in wireline receivers, such as Ethernet receivers, or in wireless receivers (such as cellular phone receivers and 5G receivers). The receiver PHY circuitry 100 includes an analog front-end circuit 102 (shown in FIG. 1A) and a digital signal processing circuit 104 (shown in FIGS. 1A and 1B). The analog front-end circuit 102 receives transmitted signals and digitizes the received signals for processing by the digital signal processing circuit 104. The digital signal processing circuit 104 processes the digitized signals to compensate for the channel through which the signals pass to the digital signal processing circuit 104. The analog front-end circuit 102 includes a high-pass filter (HPF) 103, a programmable gain amplifier (PGA) 105, an interleaved ADC 106, a clock source 150, a delay circuit 112, and a delay circuit 114.

The clock source 150 includes a divide-by-2 circuit 151 and a phase interpolator 153. The clock source 150 generates clock signals that control the conversion timing of the interleaved ADC 106. In some implementations, the phase interpolator 153 receives an input clock signal from an oscillator circuit, such as a phase-locked loop, and adjusts a phase of the input clock signal (e.g., by adjusting a delay applied to the input clock signal based on the PHASE UP/DOWN signal). An input of the divide-by-2 circuit 151 is coupled to an output of the phase interpolator 153. The divide-by-2 circuit 151 divides the input clock signal by two for provision to the delay circuits 112 and 114, and the interleaved ADC 106. However, for the examples that include M interleaved ADCs, the input clock signal is divided by M. The interleaved ADC 106 includes an ADC 108 and an ADC 110 connected in parallel with the ADC 108. The ADCs 108 and 110 may be, for example, flash ADCs, pipeline ADCs, or ADCs based on voltage-to-delay technology (e.g., ADCs based on a comparators/delays that work on the principle of comparisons based on signal delay as opposed to signal magnitudes). The ADC 108 has an input coupled to an input of the ADC 110, and to the PGA 105. The PGA 105 is coupled to a high-pass filter circuit 103.

An input of the delay circuit 112 is coupled to a first output of the divide-by-2 circuit 151, and an input of the delay circuit 114 is coupled to a second output of the divide-by-2 circuit 151. The delay circuit 112 passes a clock signal from the divide-by-2 circuit 151 to the ADC 108. The delay circuit 114 passes a clock signal from the divide-by-2 circuit 151 to the ADC 110. The delay circuit 112 and the delay circuit 114 delay the clock signals provided to the ADC 108 and the ADC 110 to compensate for variable delays in the ADC 108 and the ADC 110 or the clock paths to the ADC 108 and the ADC 110. The delay circuits 112 and 114 may include, for example, a selectable number of buffers connected in series to allow variation in delay. The delay circuit 112 includes an input coupled to the clock source 150, an output coupled to the clock input of the ADC 108, and a control input coupled to the digital signal processing circuit 104 for receipt of a delay control signal (iADC_dly_CONTROL). The delay circuit 114 includes an input coupled to the clock source 150, an output coupled to the clock input of the ADC 110, and a control input coupled to the digital signal processing circuit 104 for receipt of a delay control signal (iADC_dly_CONTROL).

The digital signal processing circuit 104 includes a first-in-first-out (FIFO) memory 116, multipliers 118, multiple processing channels (in which a processing channel 120 and a processing channel 122 are shown), and echo cancellation circuitry 124. The digital signal processing circuit 104 also includes a fine gain control circuit 146, a decision feedback equalizer (DFE) circuit 148, a clock recovery circuit 152, an interleaving ADC gain control circuit 144, and an interleaving ADC timing error detector circuit 142, and coarse automatic gain control (CAGC) circuit 154.

The FIFO memory 116 stores digital samples received from the interleaved ADC 106, and provides each sample to one of the multiple processing channels. Processing channel 120 receives, from the FIFO memory 116, and processes digital samples produced by the ADC 108. Processing channel 122 receives, from the FIFO memory 116, and processes digital samples produced by the ADC 110. Thus, each processing channel processes digital samples produced from one of the ADC 108 or the ADC 110. Implementations of the digital signal processing circuit 104 include more than two processing channels. For example, an implementation of the digital signal processing circuit 104 includes six processing channels, where three of the processing channels process samples produced by the ADC 108, and three of the processing channels process samples produced by the ADC 110.

Each processing channel includes equalization and echo cancellation circuitry 107, an adder, and a slicer. The equalization and echo cancellation circuitry 107 includes echo cancellation circuitry 124, a multiplier circuit (e.g., multiplier 126 or 128), a digital equalizer 130, and a feed-forward equalizer 132. In the processing channel 120, the echo cancellation circuitry 124 is coupled to the digital equalizer 130 via the multiplier 128, and the feed-forward equalizer 132 is coupled to the slicer 138 via the adder 134. The echo cancellation circuitry 124 multiplies received symbols by echo cancellation coefficients to reduce echo in the received signal. The digital equalizer 130 is a digital filter that corrects for ISI due to the transmission channel. The feed-forward equalizer 132 corrects pre-cursor ISI (ISI resulting from a previously transmitted symbol). The feed-forward equalizer 132 may be implemented using a finite impulse response (FIR) filter. The multiplier 128 has an input coupled to the output of the echo cancellation circuitry 124. An output of the multiplier 128 is coupled to an input of the digital equalizer 130. The adder 134 has an input coupled (via the feed-forward equalizer 132) to the output of the digital equalizer 130, and an output coupled to the input of the slicer 138.

In the processing channel 122, the echo cancellation circuitry 124 is coupled to the digital equalizer 130 via the multiplier 126, and the feed-forward equalizer 132 is coupled to the slicer 140 via the adder 136. The multiplier 126 has an input coupled to the output of the echo cancellation circuitry 124. An output of the multiplier 126 is coupled to an input of the digital equalizer 130. The adder 136 has an input coupled (via the feed-forward equalizer 132) to the output of the digital equalizer 130, and an output coupled to the input of the slicer 140.

The CAGC circuit 154 analyzes the amplitude of signal output by the ADC 106 and provides a control signal GAIN CONTROL to adjust the amplitude of the signal output of the ADC 106 to a predetermined range by selecting the gain applied by the programmable gain amplifier 105.

The fine gain control circuit 146, DFE circuit 148, clock recovery circuit 152, interleaving ADC gain control circuit 144, and interleaving ADC timing error detector circuit 142 are each coupled to the slicers (e.g., the slicer 138 and/or the slicer 140). The fine gain control circuit 146 is coupled to an input of the multiplier 128 and coupled to an input of the multiplier 126. The fine gain control circuit 146 controls the fine gain applied to the output of the echo cancellation circuitry 124 by the multiplier 128 and the multiplier 126. The fine gain control circuit 146 compares the received signal at the slicers to a predetermined amplitude value. Based on a result of the comparison, the fine gain control circuit 146 provides an output signal (DIG GAIN) that sets the gain (or attenuation) provided via the multipliers 126 and 128. The gain adjustment is selected to bring the received signal to the predetermined amplitude.

The clock recovery circuit 152 estimates the clock phase from the received signal. Based on the comparison, the clock recovery circuit 152 provides a signal PHASE UP/DOWN that adjusts the delay applied to the clock signal by the phase interpolator 153. The goal of the phase adjustment is to set the edge timing of the clock signals to sample the received signal at the optimum point.

The ADC gain control circuit 144 adjusts the gain of a signal in the processing channel 122 to equalize the amplitude of samples output by the ADC 108 and samples output by the ADC 110. An input of the ADC gain control circuit 144 is coupled to the outputs of the slicers (e.g., the slicers 138 and 140). A multiplier 118 is coupled between the FIFO memory 116 and the echo cancellation circuitry 124 to adjust the amplitude of samples produced by the ADC 110 responsive to control (a multiplier value iadc_gain) provided by the ADC gain control circuit 144. The multiplier 118 includes an input coupled to an output of the FIFO memory 116, an input coupled to the output of the ADC gain control circuit 144, and an output coupled to an input of the echo cancellation circuitry 124. An input of the echo cancellation circuitry 124 is coupled to an output of the FIFO memory 116. Thus, gain adjustment may be provided to the digital samples generated by the ADC 110, and no gain adjustment may be provided to the digital samples generated by the ADC 108. That is, the gain applied to the digital samples generated by the ADC 110 may be made equal to that applied to the digital samples generated by the ADC 108. In an alternative example, gain adjustment may be provided to both the digital samples generated by ADC 108 and ADC 110.

The ADC gain control circuit 144 determines the gain error of the ADC 110 relative to the ADC 108 based on the inputs and output of the slicers 138 and 140. Noise at the slicers 138 and 140 is reduced relative to noise earlier in the processing path because echo is cancelled by the echo cancellation circuitry 124 and ISI is removed by the DFE circuit 148. The ADC gain control circuit 144 exploits the Ethernet modulation (PAM-3) to determine gain error of the interleaved ADC 106 without using a multiplier or squarer to compute signal power. PAM-3 is only three levels (1, 0, and −1). The ADC gain control circuit 144 folds the values to a positive number, applies a simple subtraction, and returns a non-zero value only when both symbol decisions are non-zero. Otherwise, determination of gain error requires a multiplier or squarer.

The interleaving ADC timing error detector circuit 142 determines the timing error of the ADC 110 relative to the ADC 108 based on the output signals and the input signals of the slicers (e.g., slicers 138 and 140). In the receiver PHY circuitry 100, ISI seen by the processing channels coupled to the ADC 108 and the ADC 110 is different due to sampling time offset in the ADC 108 and ADC 110. The interleaving ADC timing error detector circuit 142 compares the post-cursor ISI seen in the processing channels 120 and 122 to steer the timing of the interleaved ADC 106 using the delay circuit 112 and the delay circuit 114. The interleaving ADC timing error detector circuit 142 includes an output coupled to the control input of the delay circuit 112, and an output coupled the control input of the delay circuit 114 for controlling the delay of the delay circuit 112 and the delay circuit 114.

The DFE circuit 148 is used to cancel post-cursor ISI. It stores the past symbol decisions, estimates DFE coefficients (or the post-cursor values), and stores the past symbol decisions. The coefficients are applied to weight the stored past symbol decisions and recreate the post-cursor ISI to subtract at the slicer inputs. The DFE circuit 148 is coupled to an input of the adder 134 and an input of the adder 136 to provide equalization feedback to the input of the slicer 138 and the slicer 140.

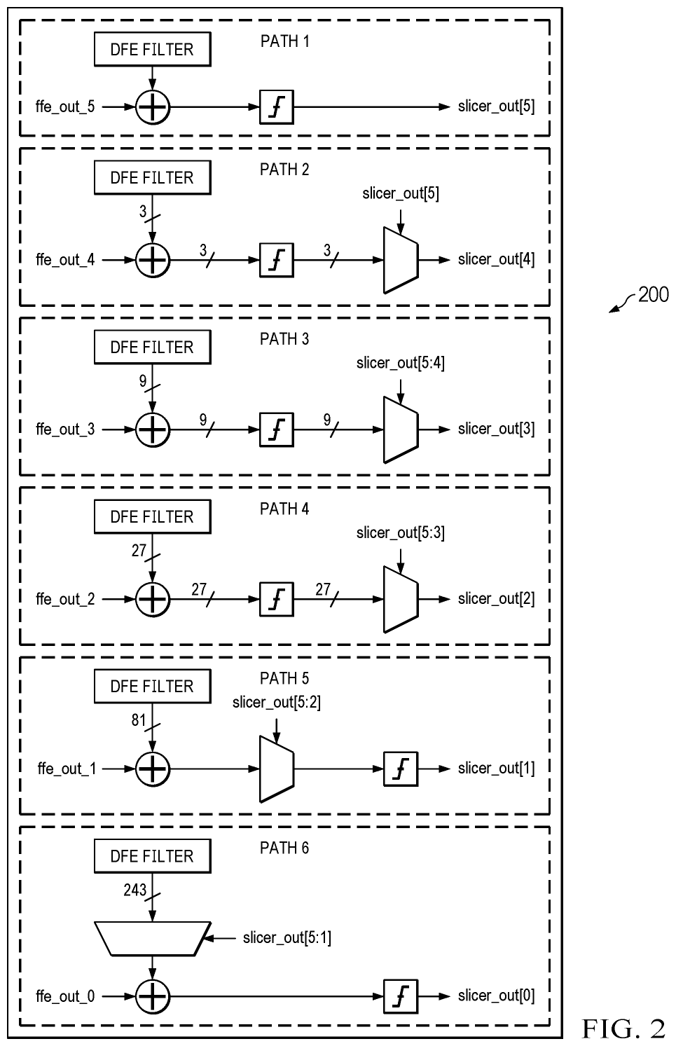

Implementation of the DFE circuit 148 can be challenging in that some methods of accelerating processing, such as pipelining and parallel processing are ineffective in feedback circuits like the DFE circuit 148. FIG. 2 is a block diagram of an example parallel DFE circuit 200 suitable for use as the DFE circuit 148. The example DFE circuit 200 includes six decision feedback equalizer paths (PATHS 1-6). Each decision feedback equalizer path operates in one of the processing channels of the digital signal processing circuit 104. For example, PATH 1 operates in the processing channel 120, PATH 6 operates in the processing channel 122, and PATHs 2-5 operate in four other processing channels (not shown) of the digital signal processing circuit 104. Each decision feedback equalizer path is coupled to an output of the feed forward equalizer 132, and includes a DFE filter circuit, a summation circuit, a slicer, and a multiplexer circuit. The DFE circuit 200 implements a look-ahead DFE architecture in which the DFE filter circuits of each path compute all the possible results of previous symbols, and selects one of the results as a final output value. In a baseline version of the DFE circuit 200, the circuitry and power needed to compute results increases substantially with each higher decision equalizer path. For example, decision equalizer path 2 includes circuitry to compute results for 3 symbols (with PAM-3), and decision equalizer path 6 includes circuitry to compute results for 243 symbols.

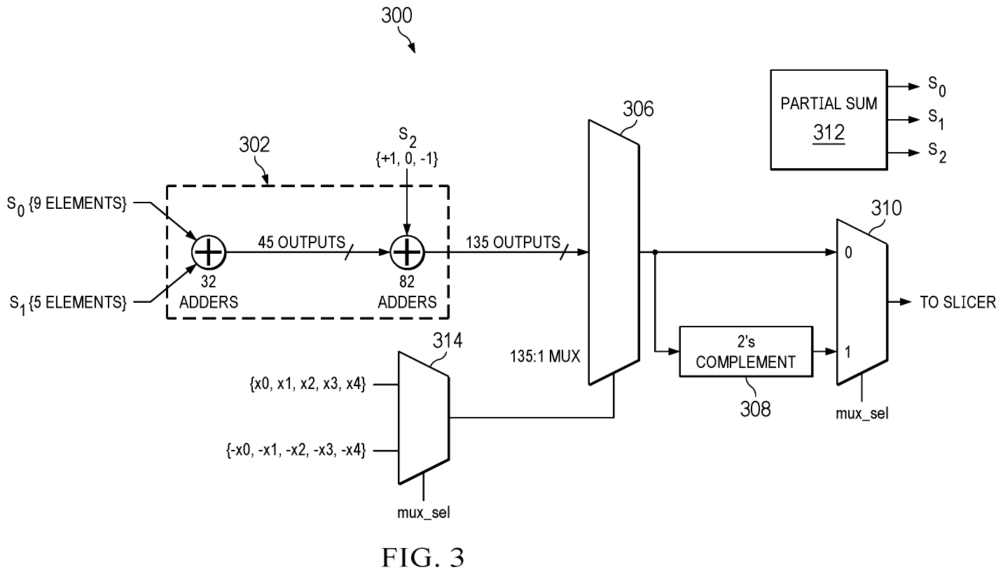

Examples of the DFE circuit 200 described herein reduce the circuitry of the decision equalizer paths to reduce circuit area and power consumption. FIG. 3 is a block diagram of example circuitry 300 of decision equalizer path 6 that takes advantage of symmetry of path output values to reduce path circuitry. The circuitry 300 includes an adder circuit 302, a multiplexer 306, a two's complement circuit 308, and a multiplexer 310. The circuitry 300 may also include a partial sum circuit 312.

The partial sum circuit 312 sums various subsets of possible results of the decision feedback equalization paths weighted by coefficients. For example:

$${S}_{0} = {K}_{0} * {Coeff}_{0} + {K}_{1} * {Coeff}_{1}$$

$${S}_{1} = {K}_{2} * {Coeff}_{2} + {K}_{3} * {Coeff}_{3}$$

where K₀, K₁, K₂, K₃ ∈{1, 0, −1} and Coeff₀, Coeff₁, Coeff₂, and Coeff₃ are filter coefficients.

The partial sum values may be used in the adder circuit 302 coupled to the multiplexer 306. For example, if the multiplexer 306 is a 135 to 1 multiplexer, then the adder circuit 302 may include a plurality of adders coupled to each of the 135 inputs of the multiplexer 306. The adder circuit 302 may be coupled to outputs of the partial sum circuit 312, and include adders that sum the partial sum values generated by the partial sum circuit 312 (and/or other weighted result values). For example, the adder circuit 302 may sum S₀, S₁, and S₂ as shown in FIG. 3. A control input of the multiplexer 306 is coupled to an output of a multiplexer 314. The inputs of the multiplexer 314 are coupled to the outputs of slicers of decision feedback equalization paths 1-5, where x0, x1, x2, x3, and x4 represent the slicer outputs of decision feedback equalizer paths 1, 2, 3, 4, and 5, respectively. The multiplexer 314 is controlled by a control signal mux_sel that may be derived from the states of x2 and x3. For example, given states of x2 and x3 shown in Table 1 below, mux_sel may be a logic one value for states 6-9, and a logic zero for all other states.

TABLE 1

| | x2 | x3 |
|---|---|---|
| 1 | 1 | 1 |
| 2 | 1 | 0 |
| 3 | 1 | −1 |
| 4 | 0 | 1 |
| 5 | 0 | 0 |
| 6 | 0 | −1 |
| 7 | −1 | 1 |
| 8 | −1 | 0 |
| 9 | −1 | −1 |

The multiplexer 310 includes a first input coupled to the output of the multiplexer 306. The two's complement circuit 308 includes an input coupled to the output of the multiplexer 306 and an output coupled to a second input of the multiplexer 310. A control input of the multiplexer 310 may be controlled by controlled by mux_sel. In the baseline version of the decision feedback equalizer path 6, 243 adder circuits are coupled to a multiplexer. Of the 243 outputs of the adder circuits, one will be zero. In the circuitry 300, 121 of the remaining 242 outputs are computed by combining S₀ (nine elements) with half of S₁ (five elements). The remaining 121 outputs are generated by negation in the two's complement circuit 308, which significantly reduces the adder and multiplexer circuitry of the circuitry 300 relative to the baseline. For example, the baseline version includes 200 adders and a 243 to 1 multiplexer. Whereas, the circuitry 300 includes 120 adders (40% reduction) and a 135 to 1 multiplexer (45% reduction).

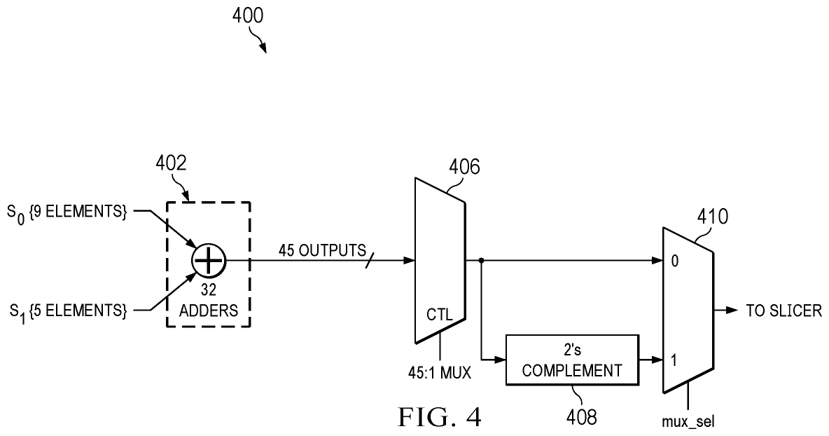

FIG. 4 is a block diagram of an example circuitry 400 of decision equalizer path 5 that takes advantage of symmetry of path output values to reduce path circuitry. The circuitry 400 includes an adder circuit 402, a multiplexer 406, a two's complement circuit 408, and a multiplexer 410. The circuitry 400 is similar to the circuitry 300, and provides a similar reduction in circuitry.

The partial sum values generated by the partial sum circuit 312 may be used in the adder circuit 402 coupled to the multiplexer 406. For example, if the multiplexer 406 is a 45 to 1 multiplexer, then the circuitry 400 includes adders coupled to each of the 45 inputs of the multiplexer 406. The adder circuit 402 may be coupled to outputs of the partial sum circuit 312, and include adders that sum the partial sum values generated by the partial sum circuit 312 (and/or other weighted result values). For example, the adder circuit 402 sums S₀ and S₁, as shown in FIG. 4. Control inputs (CTL) of the multiplexer 406 may be coupled to the output of slicers of decision feedback equalizer paths 1-4.

The multiplexer 410 includes a first input coupled to the output of the multiplexer 406. The two's complement circuit 408 includes an input coupled to the output of the multiplexer 406 and an output coupled to a second input of the multiplexer 410. A control input of the multiplexer 410 may be controlled by mux_sel. In an example of the baseline version of the decision feedback equalizer path 5, 72 adders are used in the adder circuits coupled to an 81 to 1 multiplexer. An example of the circuitry 300 may include 40 adders (45% reduction) and a 45 to 1 multiplexer (45% reduction).

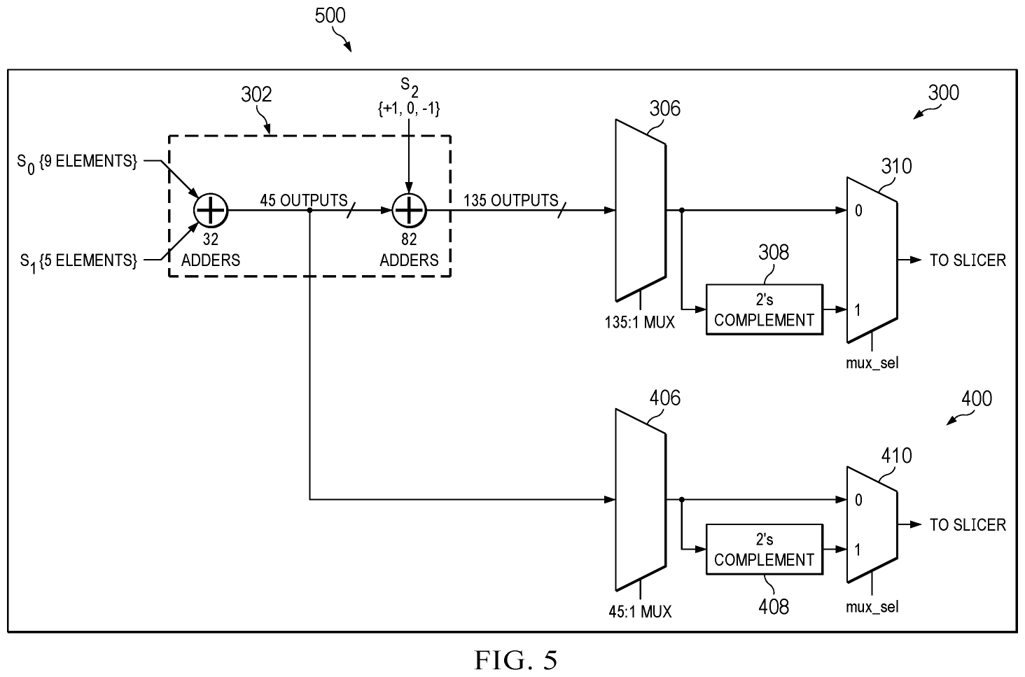

FIG. 5 is a block diagram of example circuitry 500 of decision feedback equalizer paths 5 and 6 using the circuitry 300 and the circuitry 400 in which a partial sum determined in the circuitry 300 is used in the circuitry 400. In FIG. 5, a first output of the adder circuit 302 (S₀+S₁+S₂) is coupled to the multiplexer 306, and a second output of the adder circuit 302 (S₀+S₁) is coupled to the multiplexer 406. The circuitry 300 and the circuitry 400 as shown in FIGS. 3 and 4 use 160 adders. Reuse of (S₀+S₁) generated in the circuitry 300 reduces the number of adders in the circuitry 500 to 120.

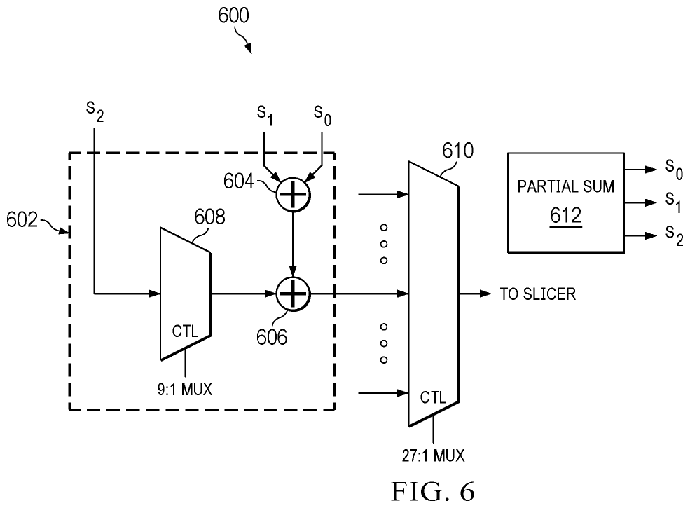

FIG. 6 is a block diagram of an example circuitry 600 of decision equalizer path 6 that takes advantage of sequential computation of results in previous decision feedback equalizer paths. The circuitry 600 includes an adder circuit 602 and a multiplexer 610. An input of the multiplexer 610 is coupled to an output of the adder circuit 602. The adder circuit 602 includes an adder 604, an adder 606, and a multiplexer 608. The circuitry 600 may also include a partial sum circuit 612.

In the DFE circuit 200, PATH 1 has less dependency than the other paths, and its result is available earlier than the other paths. The circuitry 600 selects the partial sums for use in the adder circuit 602 in order of availability to reduce circuitry. The partial sum circuit 612 may define the partial sums to facilitate sequential selection. For example:

$${S}_{0} = {h}_{0} * {dfe}_{0}$$

$${S}_{1} = {h}_{1} * {dfe}_{2} + {h}_{2} * {dfe}_{2}$$

$${S}_{2} = {h}_{3} * {dfe}_{3} + {h}_{4} * {dfe}_{4}$$

where hₙ is a result from path n and dfeₙ is a coefficient.

The adder 604 is coupled to the partial sum circuit 612 for summation of S₀ and S₁. The adder 606 is coupled to the adder 604 and the multiplexer 608 for summation of the output of the adder 604 and S₂ as selected by the multiplexer 608. The output of the adder 606 is coupled to an input of the multiplexer 610. Control inputs (CTL) of the multiplexer 610 are coupled to slicer outputs of the decision feedback equalizer paths 3-5. The multiplexer 608 may be a 9 to 1 multiplexer, and the multiplexer 610 may be a 27 to 1 multiplexer. The adder circuit 602 may include 51 adders, which reduces the number of adders by about 75% relative to path 6 of the baseline decision feedback equalizer (200 adders). Control inputs (CTL) of the multiplexer 608 are coupled to slicer outputs of the decision feedback equalizer paths 1 and 2. Multiplexer circuitry of the circuitry 600 may be reduced by about 80% relative to the 243:1 multiplexer of path 6 of the baseline decision feedback equalizer.

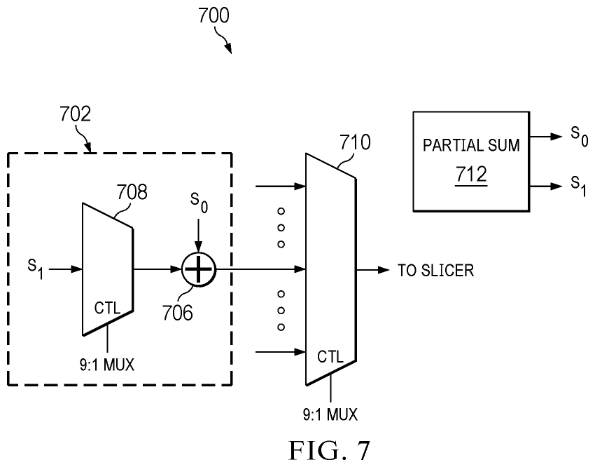

FIG. 7 is a block diagram of an example circuitry 700 of decision equalizer path 5 that takes advantage of sequential computation of results in previous decision feedback equalizer paths. The circuitry 700 is similar, in principle, to the circuitry 600. The circuitry 700 includes an adder circuit 702 and a multiplexer 710. An input of the multiplexer 710 is coupled to an output of the adder circuit 702. The adder circuit 702 includes an adder 706 and a multiplexer 708. The circuitry 700 may also include a partial sum circuit 712.

In the DFE circuit 200, PATH 1 has less dependency than the other paths, and its result is available earlier than the other paths. The circuitry 700 selects the partial sums for use in the adder circuit 702 in order of availability to reduce circuitry. The partial sum circuit 712 may define the partial sums to facilitate sequential selection. For example:

$${S}_{0} = {h}_{0} * {dfe}_{0} + {h}_{1} * {dfe}_{1}$$

$${S}_{1} = {h}_{2} * {dfe}_{2} + {h}_{3} * {dfe}_{3}$$

where hₙ is a result from path n and dfeₙ is a coefficient.

The adder 706 is coupled to the partial sum circuit 712 and the multiplexer 708 for summation of the output of S₀ and S₁ as selected by the multiplexer 708. The output of the adder 706 is coupled to an input of the multiplexer 710. Control inputs (CTL) of the multiplexer 710 are coupled to slicer outputs of the decision feedback equalizer paths 3 and 4. The multiplexer 708 may be a 9 to 1 multiplexer, and the multiplexer 710 may be a 9 to 1 multiplexer. Control inputs (CTL) of the multiplexer 708 are coupled to slicer outputs of the decision feedback equalizer paths 1 and 2. The adder circuit 702 may include 17 adders, which reduces the number of adders by about 75% relative to path 5 of the baseline decision feedback equalizer (72 adders). Multiplexer circuitry of the circuitry 700 may be reduced by about 80% relative to the 81:1 multiplexer of path 5 of the baseline decision feedback equalizer.

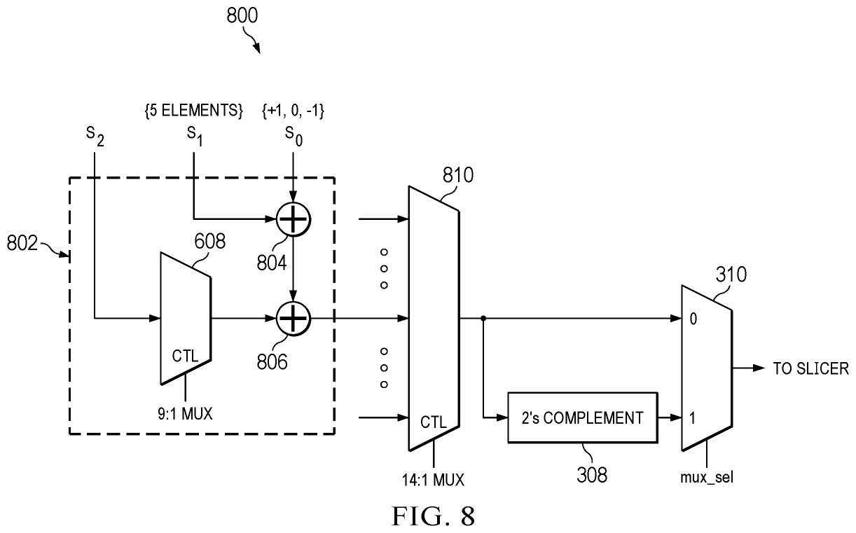

FIG. 8 is a block diagram of an example circuitry 800 of a decision feedback equalizer path that includes the multiplexing of circuitry 600 and the symmetry exploitation of the circuitry 300. The circuitry 800 includes an adder circuit 802, a multiplexer 810, the two's complement circuit 308, and the multiplexer 310. Because of the negation provided by the two's complement circuit 308, the multiplexer 810 may be a 14 to 1 multiplexer, rather than the 27 to 1 multiplexer 610. Control inputs (CTL) of the multiplexer 810 are coupled to slicer outputs of the decision feedback equalizer paths 3-5. The adder circuit 802 may not generate the results provided by the two's complement circuit 308. Accordingly, the number of adders in the adder circuit 802 may be reduced relative to the adder circuit 602. For example, the adders 804 and 806 may include 31 adders rather than the 51 adders of the adders 604 and 606.

Various implementations of DFE circuit 200 may include any combination of the circuitry 300, the circuitry 400, the circuitry 500, the circuitry 600, and/or the circuitry 700.

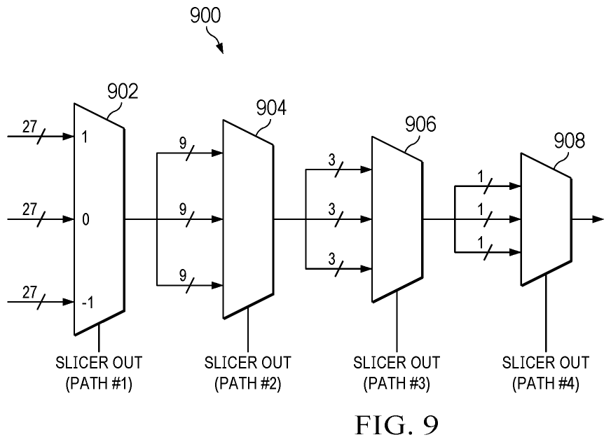

FIG. 9 is a block diagram of an example multiplexer 900 suitable for use in the decision feedback paths of the DFE circuit 200. The multiplexer 900 is illustrated as an example of an 81 to 1 multiplexer. Other examples of the multiplexer 900 may implement a different multiplexing ratio. In the DFE circuit 200, the outputs of PATH 1 will be stable before the outputs of PATH 2, and the outputs of PATH 2 will be stable before the outputs of PATH 3, etc. The multiplexer 900 takes advantage of this sequence to reduce multiplexer circuit activity. An example of the multiplexer 900 may be used in any path of the DFE circuit 200.

The multiplexer 900 includes a multiplexer 902, a multiplexer 904, a multiplexer 906, and a multiplexer 908 connected in series. Each multiplexer may select one of three sets of inputs. The multiplexer 902 may select one of three sets of 27 inputs (81 inputs coupled to adders that compute possible results). The multiplexer 904 may select one of three sets of 9 inputs (27 inputs received from the multiplexer 902). The multiplexer 906 may select one of one of three sets of three inputs (9 inputs received from the multiplexer 904). The multiplexer 908 may select one of three inputs received from the multiplexer 906.

A selection input of the multiplexer 902 is controlled by the output of the PATH 1 slicer. A selection input of the multiplexer 904 is controlled by the output of the PATH 2 slicer. A selection input of the multiplexer 906 is controlled by the output of the PATH 3 slicer. A selection input of the multiplexer 908 is controlled by the output of the PATH 4 slicer. Accordingly, selection by the multiplexer 902 is complete prior to selection by the multiplexer 904, etc. Because activity in each of the multiplexers 902-908 is complete with the controlling slicer decision, the overall activity in the multiplexer 900 is substantially reduced relative to an 81 to 1 multiplexer circuit, which can substantially reduce power consumption.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

What is claimed is:

1. A circuit comprising:
a partial sum circuit configured to generate partial sum values by summing decision feedback equalizer outputs;
a first decision feedback equalizer path coupled to the partial sum circuit, the first decision feedback equalizer path including:
a first adder circuit configured to generate a sum of a first subset of the partial sum values;
a first multiplexer having a first input coupled to an output of the first adder circuit, and an output;
a first two's complement circuit having an input coupled to the output of the first multiplexer, and an output;
a second multiplexer having a first input coupled to the output of the first multiplexer, and a second input coupled to the output of the first two's complement circuit; and
a first slicer having an input coupled to the output of the second multiplexer.

2. The circuit of claim 1, further comprising:
a second decision feedback equalizer path including:
a second adder circuit configured to generate a sum of a second subset of the partial sum values;
a third multiplexer having a first input coupled to an output of the second adder circuit, and an output;
a second two's complement circuit having an input coupled to the output of the third multiplexer, and an output;
a fourth multiplexer having a first input coupled to the output of the third multiplexer, and a second input coupled to the output of the second two's complement circuit; and
a second slicer having an input coupled to the output of the second multiplexer.

3. The circuit of claim 2, wherein:
the output of the first adder circuit is a first output;
the first adder circuit has a second output; and
the circuit further comprises:
a second decision feedback equalizer path including:
a third multiplexer having a first input coupled to the second output of the first adder circuit, and an output;
a second two's complement circuit having an input coupled to the output of the third multiplexer, and an output;
a fourth multiplexer having a first input coupled to the output of the third multiplexer, and a second input coupled to the output of the second two's complement circuit; and
a second slicer having an input coupled to the output of the second multiplexer.

4. The circuit of claim 2, wherein the second adder circuit includes:
a first adder having a first input coupled to the partial sum circuit, a second input, and an output coupled to the first input of the third multiplexer; and
a fifth multiplexer having an output coupled to the second input of the first adder, and first and second inputs coupled to the partial sum circuit.

5. The circuit of claim 1, wherein first adder circuit includes:
a first adder having a first input, a second input coupled to the partial sum circuit, and an output coupled to the first input of the first multiplexer; and
a third multiplexer having an output coupled to the first input of the first adder, and first and second inputs coupled to the partial sum circuit.

6. The circuit of claim 2, further comprising:
a third decision feedback equalizer path having a third slicer;
wherein the first multiplexer includes:
a third multiplexer having a control input coupled to an output the second slicer, and a plurality of outputs; and
a fourth multiplexer having a control input coupled to an output of the third slicer, and a plurality of inputs coupled to the outputs of the third multiplexer.

7. The circuit of claim 6, wherein the output of the third slicer transitions later in time than the output of the second slicer.

8. A circuit comprising:
a partial sum circuit configured to generate partial sum values by summing decision feedback equalizer outputs;
a first decision feedback equalizer path coupled to the partial sum circuit, the first decision feedback equalizer path including:
a first adder circuit having a first output and a second output, the first adder circuit configured to generate a sum of a first subset of the partial sum values;
a first multiplexer having a first input coupled to a first output of the first adder circuit, and an output; and
a first slicer coupled to the output of the first multiplexer; and
a second decision feedback equalizer path including:
a second multiplexer having an input coupled to the second output of the first adder circuit, and an output; and
a second slicer having an input coupled to the output of the second multiplexer.

9. The circuit of claim 8, wherein the first decision feedback equalizer path includes:
a two's complement circuit having an input coupled to the output of the first multiplexer, and an output; and
a third multiplexer having a first input coupled to the output of the first multiplexer, a second input coupled to the output of the two's complement circuit, and an output coupled to the input of the first slicer.

10. The circuit of claim 8, wherein the second decision feedback equalizer path includes:
a two's complement circuit having an input coupled to the output of the second multiplexer, and an output;
a third multiplexer having a first input coupled to the output of the second multiplexer, a second input coupled to the output of the two's complement circuit, and an output coupled to the input of the second slicer.

11. The circuit of claim 10, wherein the second decision feedback equalizer path includes:
a second adder circuit including:
a first adder having a first input coupled to the partial sum circuit, a second input, and an output coupled to the first input of the second multiplexer; and
a fifth multiplexer having an output coupled to second first input of the first adder, and first and second inputs coupled to the partial sum circuit.

12. The circuit of claim 8, wherein first adder circuit includes:
a first adder having first and second inputs, and an output coupled to the first input of the first multiplexer; and
a third multiplexer having an output coupled to the first input of the first adder, and first and second inputs coupled to the partial sum circuit.

13. The circuit of claim 8, further comprising:
a third decision feedback equalizer path having a third slicer; and
the first multiplexer includes:
a third multiplexer having a control input coupled to an output the second slicer, and a plurality of outputs; and
a fourth multiplexer having a control input coupled to an output of the third slicer, and a plurality of inputs coupled to the outputs of the third multiplexer.

14. The circuit of claim 13, wherein the output of the third slicer transitions later in time than the output of the second slicer.

15. A circuit comprising:
a partial sum circuit configured to generate partial sum values by summing decision feedback equalizer outputs;
a first decision feedback equalizer path coupled to the partial sum circuit, the first decision feedback equalizer path including:
a first adder circuit configured to generate a sum of a first subset of the partial sum values, the first adder circuit including:
a first multiplexer having an input coupled to the partial sum circuit, and an output; and
a first adder having a first input coupled to the output of the first multiplexer, a second input coupled to the partial sum circuit, and an output;
a second multiplexer having a first input coupled to the output of the first adder, and an output; and
a first slicer having an input coupled to the output of the second multiplexer.

16. The circuit of claim 15, wherein the first decision feedback equalizer path includes:
a two's complement circuit having an input coupled to the output of the first multiplexer, and an output; and
a third multiplexer having a first input coupled to the output of the first multiplexer, and a second input coupled to the output of the two's complement circuit.

17. The circuit of claim 16, further comprising:
a second decision feedback equalizer path including:
a second adder circuit configured to generate a sum of a second subset of the partial sum values;
a fourth multiplexer having a first input coupled to an output of the second adder circuit, and an output;
a two's complement circuit having an input coupled to the output of the third fourth multiplexer, and an output;
a fifth multiplexer having a first input coupled to the output of the fourth multiplexer, and a second input coupled to the output of the two's complement circuit; and
a second slicer having an input coupled to the output of the second multiplexer.

18. The circuit of claim 17, wherein:
the output of the first adder circuit is a first output;
the first adder circuit has a second output; and
the circuit includes:
a second decision feedback equalizer path including:
a fourth multiplexer having a first input coupled to the second output of the first adder circuit, and an output;
a two's complement circuit having an input coupled to the output of the fourth multiplexer, and an output;
a fifth multiplexer having a first input coupled to the output of the fourth multiplexer, and a second input coupled to the output of the two's complement circuit; and
a second slicer having an input coupled to the output of the second multiplexer.

19. The circuit of claim 17, further comprising:
a third decision feedback equalizer path having a third slicer; and
the fourth multiplexer includes:
a sixth multiplexer having a control input coupled to an output the second slicer, and a plurality of outputs; and
a seventh multiplexer having a control input coupled to an output of the third slicer, and a plurality of inputs coupled to the outputs of the sixth multiplexer.

20. The circuit of claim 19, wherein the output of the third slicer transitions later in time than the output of the second slicer.
